(19) United States
(12) Patent Application Publication
(10) Pub. No.: US 2009/0020405 A1
(43) Pub. Date: Jan. 22, 2009

(54) METHOD OF AND A PLANT FOR COMBUSTING CARBONACEOUS FUEL BY USING A SOLID OXYGEN CARRIER

(75) Inventors: Zhen FAN, Parsippany, NJ (US); Horst Hack, Hampton, NJ (US); Andrew SELTZER, Livingston, NJ (US); Archibald Robertson, Whitehouse Station, NJ (US)

Correspondence Address: FITZPATRICK CELLA HARPER & SCINTO, 30 ROCKEFELLER PLAZA, NEW YORK, NY, 10112, US

(73) Assignee: Foster Wheeler Energy Corporation, Clinton, NJ (US)

(21) Appl. No.: 11/780,623

(22) Filed: Jul. 20, 2007

(51) Int. Cl. C10B 49/22; C10B 1/00; B01J 8/26

(52) U.S. Cl. 201/12; 201/31; 201/36; 201/28; 202/108; 202/99; 422/142; 422/146

(57) ABSTRACT

A method of and a plant for combusting carbonaceous fuel, the method including the steps of introducing particulate oxygen selective sorbent, such as a perovskite type material, into an adsorption reactor of the combustion plant to form a first particle bed in the adsorption reactor, fluidizing the first particle bed by an oxygen-containing first fluidizing gas to adsorb oxygen from the fluidizing gas to the sorbent, conveying oxygen-rich sorbent from the adsorption reactor to a combustion reactor of the combustion plant to form a second particle bed in the combustion reactor, fluidizing the second particle bed by an oxygen-deficient second fluidizing gas to desorb oxygen from the sorbent, so as to produce free oxygen gas, and introducing carbonaceous fuel into the combustion reactor to oxidize the fuel with the free oxygen gas.

### BACKGROUND OF THE INVENTION

1. Field of the Invention

The present invention relates to a method of and a plant for combusting carbonaceous fuel in a fluidized bed by transporting oxygen to the combustion process by a solid oxygen carrier material. More particularly, the present invention relates to a power generation process where oxygen is fixed into a solid oxygen carrier material in a first fluidized bed and carbonaceous fuel is combusted in another fluidized bed by the oxygen released from the oxygen carrier material.

2. Description of the Related Art

Chemical looping combustion is a technology proposed for combusting fuels by transporting oxygen from combustion air to the fuel by means of an oxide compound acting as a solid oxygen carrier. The fuel is introduced in the so-called fuel reactor, or combustion reactor, and the fixing of oxygen from air to a suitable oxide compound is accomplished in another reactor, a so-called air reactor, or a regeneration reactor. The main advantage of using chemical looping combustion instead of conventional combustion in a single stage is that the CO₂ produced in the combustion reactor is not diluted with nitrogen gas. Thus, the exhaust gas from the combustion reactor is, after separation of water, almost pure carbon dioxide, and does not require extra energy or costly external equipment for CO₂ separation.

The development of chemical looping combustion, being new, is still in the pilot plant and the materials testing stage. Metal oxides, especially certain oxides of common transition-state metals, such as iron, nickel, copper and manganese have been suggested to be used as the oxygen carrier. The chemical looping principle may be applied either in a gas turbine cycle by having pressurized reactors for the fuel combustion and carrier regeneration, or in a steam turbine cycle with atmospheric pressure in the reactors.

The oxidation of the oxygen carrier with air in the air reactor is an exothermic reaction. Thus, a large amount of energy is to be recovered from the exhaust gas, oxygen-depleted air, discharged from the air reactor. Correspondingly, the reduction of the oxygen carrier in the combustion reactor is an endothermic reaction and consumes a considerable portion of the energy provided by the combustion of the fuel. While the decomposition of the oxygen carrying compound takes place only at a sufficiently high temperature, the combustion reactor also produces hot exhaust gas, mainly CO₂ and water.

U.S. Pat. No. 5,447,024 discloses a method of generating power by chemical looping combustion, wherein hydrocarbon fuel is reacted with a metallic oxide in a fuel reactor to produce a first off gas containing carbon dioxide and water, and to reduce the metallic oxide to a reduced solid product. The reduced solid product is oxidized by air in an air reactor whereby a metal oxide, to be recycled to the fuel reactor, and a second off gas are produced. The first and second off gases are passed through first and second turbines, respectively, to produce power. Because of the chemical reaction between the fuel and the metallic oxide, the method is only suitable for liquid or gaseous fuels. Another drawback of the method is its complexity, especially because of the two turbines that are required to produce the power.

U.S. Pat. No. 6,572,761 discloses a chemical looping combustion process intended for combusting coal or biomass by using iron oxides as an oxygen carrier. According to the patent, the rate of addition of sulfur-containing fuel to the combustion bed is adjusted so as to minimize the formation of FeS, which might otherwise be transported to the air reactor. In this process it is, however, questionable whether the solid fuels can be efficiently oxidized with Fe₂O₃, except for the combustible volatile compounds released from the fuel.

It has also been suggested to use chemical looping combustion for combusting solid fuel by first gasifying the fuel in a separate gasifier. This, however, would require another reactor for the gasification, which would make the plant even more complicated. The additional gasification step would also generally reduce the efficiency and carbon conversion of the plant.

U.S. Pat. No. 6,143,203 discloses a process for partial oxidation of hydrocarbons, where a perovskite-type ceramic mixed conductor is circulated between an adsorption zone at an elevated temperature, for saturating the mixed conductor with oxygen, and a partial oxidation zone, for contacting the hot oxygen-saturated mixed conductor with a hydrocarbon. During the partial oxidation phase of the process, the sorbent reacts with the hydrocarbon, thereby producing hydrogen and carbon monoxide. For safety reasons, the oxygen-depleted mixed conductor removed from the partial oxidation is treated in a stripping section to remove residual unreacted hydrocarbon and/or partial oxidation reaction products prior to being returned to the adsorption unit.

### SUMMARY OF THE INVENTION

An object of the present invention is to provide an efficient method of combusting carbonaceous fuel by transporting oxygen to the combustion process by using a solid oxygen carrier material.

Another object of the present invention is to provide an efficient system for combusting carbonaceous fuel by transporting oxygen to the combustion process by using a solid oxygen carrier material.

According to an aspect of the present invention, a method of combusting carbonaceous fuel in a combustion plant is provided, the method comprising the steps of: (a) introducing particulate oxygen selective sorbent into an adsorption reactor of the combustion plant to form a first particle bed in the adsorption reactor; (b) fluidizing the first particle bed by an oxygen-containing fluidizing gas to provide a first partial pressure of oxygen p₁ in the adsorption reactor to adsorb oxygen from the fluidizing gas to the sorbent, so as to produce oxygen-rich sorbent and oxygen-depleted exhaust gas; (c) discharging oxygen-depleted exhaust gas from the adsorption reactor along a first exhaust gas channel; (d) conveying oxygen-rich sorbent from the adsorption reactor to a combustion reactor of the combustion plant along a sorbent conveying channel to form a second particle bed in the combustion reactor; (e) fluidizing the second particle bed by an oxygen-deficient fluidizing gas to provide a second partial pressure of oxygen p₂ in the combustion reactor, where p₂ is less than p₁, to desorb oxygen from the sorbent, so as to produce free oxygen gas and oxygen-depleted sorbent; (f) introducing carbonaceous fuel into the combustion reactor to oxidize the fuel with the free oxygen gas, and to produce carbon dioxide containing exhaust gas, and to maintain a low partial pressure of oxygen p₂′ in the combustion reactor, where p₂′ is less than p₁, to continue desorbing oxygen from the sorbent, and (g) discharging carbon dioxide containing exhaust gas from the combustion reactor along a second exhaust gas channel.

According to another aspect of the present invention, an apparatus for combusting carbonaceous fuel is provided, wherein the apparatus comprises an adsorption reactor and a combustion reactor, means for introducing particulate oxygen selective sorbent into the adsorption reactor, means for fluidizing a bed provided by the oxygen selective sorbent by an oxygen-containing fluidizing gas for producing oxygen-rich sorbent and oxygen-depleted exhaust gas, means for discharging oxygen-depleted exhaust gas from the adsorption reactor; means for conveying oxygen-rich sorbent from the adsorption reactor to the combustion reactor, means for fluidizing a bed provided into the combustion reactor by a second fluidizing gas, which does not contain free oxygen, so as to desorb oxygen from the sorbent, means for introducing carbonaceous fuel into the combustion reactor to oxidize the fuel with the desorbed oxygen, so as to produce oxygen-depleted sorbent and carbon dioxide containing exhaust gas, and to maintain a sufficiently low partial pressure of oxygen in the combustion reactor so as to continuously desorb oxygen from the sorbent; and means for discharging carbon dioxide containing exhaust gas from the combustion reactor.

The use of a fluidized bed in both the adsorption reactor and the combustion reactor provides the advantage of promoting good heat and mass transfer throughout the reactors and the temperature distribution in each reactor becomes more uniform. Fluidized bed operation also provides uniform distribution of the materials throughout the reactor and good contact between the gas and solid phases. All the steps of the method are preferably carried out continuously, at an approximately constant rate. Typically, various parameters of the process, such as temperatures and pressures, are monitored by conventional means, and the different feed rates are adjusted to maintain stable process conditions. Alternatively, in some cases, it may be useful to carry out the process in a cyclically varying mode.

The oxygen selective sorbent is here defined as a material that quickly changes the content of oxygen physically adsorbed onto the material as a function of the partial pressure of oxygen. The physical adsorption may exist together with a weak chemical bond. An essential feature of the sorbent is that due to varying partial pressures of oxygen, oxygen is adsorbed in or released from the adsorbent material. As a result of using an oxygen selective sorbent as an oxygen carrier, the combustion occurs between the fuel and the released oxygen in free space or on the solid fuel surface, which allows solid fuels to be directly applicable for the combustion process with good combustion performance. This is in clear contrast with a chemical looping combustion process, which undergoes an oxidation-reduction reaction (redox-reaction) on the surface of the oxygen carrier, and is thus not directly applicable to solid fuels.

The combustion method according to the present invention advantageously contains a further step of conveying at least a portion of the oxygen-depleted sorbent along a suitable return channel from the combustion reactor to the adsorption reactor for reloading the sorbent used with oxygen. Thereby, the oxygen selective sorbent is recirculated between the combustion reactor and the adsorption reactor, which may then alternatively be called a regeneration reactor. Recirculating of the sorbent naturally lowers the costs of the process.

However, especially when the sorbent is a low-cost material, it may be advantageous to dispose of the used sorbent. A process based on disposing the oxygen-depleted sorbent may be useful, for example, when the sorbent tends to become deteriorated by impurities in the fuel, such as sulfur. In that case, the method includes a further advantage of removing sulfur, or other impurities, from the process by the sorbent. In some applications, this is a more efficient and cost effective solution than the conventional removal of the impurities from the exhaust gas of the combustion reactor.

Sorbent material poisoned by impurities may advantageously, after it has been extracted from the circulation, be regenerated in a further process step. The sorbent regeneration may, for example, include a suitable heat treatment combined with impurity recovery. According to an advantageous embodiment of the present invention, a portion of the sorbent is recirculated as such, while another portion of the sorbent is extracted from the circulation and thereafter either disposed of and replaced by fresh sorbent, or regenerated and then brought back to the circulation.

The rates of adsorption and desorption of oxygen, as well as the rate of recirculating the oxygen-rich sorbent between the reactors are advantageously sufficiently high, in relation to the feed rate of the carbonaceous fuel, so that the fuel can be completely combusted to carbon dioxide and water. Thus, the degree of coal conversion in the combustion reactor is high, and there is no risk of escaping of combustible gases to the adsorption reactor. Thereby, there is no need to strip any combustible product gases from the oxygen-depleted sorbent material when recirculating the sorbent material from the combustion reactor to the adsorption reactor.

The oxygen-containing fluidizing gas, i.e., the fluidizing gas introduced to the adsorption bed, is preferably air. It may, however, in some cases alternatively be other oxygen-containing gas, such as oxygen-enriched air. An object of the fluidization air is to continuously provide in the adsorption reactor such a partial pressure of oxygen p₁ that oxygen is efficiently adsorbed from the fluidizing gas to the sorbent. Thereby, oxygen-rich sorbent and oxygen-depleted exhaust gas are produced in the adsorption reactor.

The second fluidizing gas, i.e., the fluidizing gas of the combustion reactor, is advantageously mainly carbon dioxide. Thereby, the exhaust gas discharged from the combustion reactor consists mainly of carbon dioxide, including CO₂ generated in the combustion process, as well as that from the fluidizing gas, and water. Thus, carbon dioxide can be recovered relatively easily from the exhaust gas by generally known methods. The carbon dioxide used as the fluidizing gas is advantageously obtained as a side stream of the exhaust gas discharged from the combustion reactor. This solution provides a simple way of producing the second fluidizing gas and minimizes the need for CO₂ recovery. The second fluidizing gas may in some cases alternatively be a gas other than carbon dioxide, such as a mixture of carbon dioxide and steam. A preferred solution is to use a mixture of the exhaust gas and some other suitable gas as the second fluidizing gas. A requirement for the second fluidizing gas is that it may not hamper the recovery of carbon dioxide from the exhaust gas.

Especially, it is noticed, that the second fluidizing gas is not air, which would dilute the exhausted carbon dioxide with nitrogen. Preferably, the second fluidizing gas does not contain free oxygen, or it contains only a small amount of oxygen, such as typically 3-4% in the case when recycled exhaust gas of the combustion reactor is used as the second fluidizing gas. In any case, the amount of oxygen in the second fluidizing gas is preferably less than that in the oxygen-containing fluidizing gas introduced into the adsorption reactor.

The fluidization with such an oxygen-deficient fluidizing gas provides in the combustion reactor a partial pressure of oxygen, which is clearly less than p₁, i.e., the partial pressure of oxygen in the adsorption reactor. In such conditions, a considerable portion of the oxygen stored in the sorbent will spontaneously desorb from the sorbent. In a process where oxygen-rich sorbent and oxygen-deficient fluidizing gas are continuously introduced into the combustion reactor, and exhaust gas is continuously discharged from the reactor, the partial pressure of oxygen in the combustion reactor reaches an equilibrium value p₂, which is lower than p₁. Therefore, oxygen is continuously desorbed from the sorbent, and, in a broader view, the circulation of oxygen selective sorbent continuously transfers oxygen from the adsorption reactor to the combustion reactor. The desorption of oxygen in the combustion reactor is usually also enhanced by the temperature in the combustion reactor being higher than that in the adsorption reactor, as will be explained later.

The desorption of oxygen from the oxygen sorbent material provides in the combustion reactor free oxygen gas, which is readily usable for the combustion of the fuel. When combustible fuel is introduced to the combustion reactor, the combustion process consumes a portion of the free oxygen, and in a steady state, an even lower equilibrium partial pressure of oxygen p₂′ is reached. Thus, the combustion process automatically further enhances the desorption of oxygen from the sorbent material. Because the releasing of the oxygen from the oxygen selective sorbent material does not require contact between the fuel and the particles of the sorbent material, the fuel may advantageously be solid fuel, such as coal, biofuel or waste derived fuel.

In order to obtain good combustion performance, the circulation rate of the sorbent and the feed rate of the fuel are advantageously adjusted such that the amount of oxygen released in the combustion chamber is slightly more, advantageously, 10-25% more, than what is theoretically needed to completely combust the fuel. This excess oxygen results in that the exhaust gas from the combustion reactor contains some oxygen, which is to be taken into account in the process of recovering the CO₂ of the exhaust gas. Therefore, in order to minimize the amount of oxygen in the exhaust gas, the circulation rate of the sorbent and the feed rate of the fuel are adjusted such that the amount of oxygen released in the combustion chamber is very advantageously 10-15% more than what is theoretically needed to completely combust the fuel.

The combustion of the fuel is an exothermic reaction, and the desorption of oxygen from the sorbent material is typically a slightly endothermic reaction. Thus, typically, a small amount of the energy released by the combustion of the fuel is used for releasing the oxygen, but most of the energy is transported out from the combustion reactor, for example, by radiation to the furnace walls and in the form of hot exhaust gas. The carbon dioxide containing exhaust gas discharged from the combustion reactor has typically a temperature of 600-1200° C. According to advantageous embodiments of the present invention, the enclosure of the combustion reactor, the fluidized bed within the combustion reactor and/or the exhaust gas channel of the combustion reactor comprise heat transfer surfaces for generating steam, which is advantageously used for generating power.

It may be desirable to control the temperature in the combustion reactor, for example, to minimize the formation of carbon deposits on the oxygen selective sorbent. One method of controlling the reactor temperature is by the use of steam generating heat exchanger surfaces, which, for example, may be in the form of water tubes, preferably positioned on the walls or in the upper section of the combustion reactor. The temperature in the combustion reactor can advantageously be controlled, to some extent, also by adjusting the temperature and velocity of the fluidizing gas.

The adsorption of oxygen to the sorbent is typically only a slightly exothermic reaction, and does not release a large amount of heat into the adsorption reactor. Additional heat may be provided to the adsorption reactor by the sorbent material recycled from the combustion reactor. Generally, the rate and total amount of adsorption of oxygen into the sorbent depends on the prevailing temperature. The optimum temperature of the adsorption reactor may be, depending on the sorbent material used, for example, about 300° C. or more. For some materials, it may by about 500° C., or even more.

If the heat provided by the oxygen adsorption and recycled sorbent material is not enough to provide the desired temperature conditions for the adsorption, additional heat energy can be provided, for example, by heating, in a conventional manner, the fluidizing gas introduced into the reactor by the heat of the exhaust gas. If the temperature in the adsorption reactor tends to be too high, it can be lowered by a heat exchanger in the fluidized bed of the reactor, or in a separate fluidized bed heat exchanger arranged in the channel for conveying the oxygen depleted sorbent from the combustion reactor to the adsorption reactor. The heat recovered by such a heat exchanger can advantageously be used to increase the efficiency of a steam cycle.

Typically, the exhaust gas from the adsorption reactor has a lower temperature than does the exhaust gas from the combustion reactor. Heat energy of the exhaust gas from the adsorption reactor can advantageously be recovered by simple heat exchangers disposed in the exhaust channel of the adsorption reactor. In this respect, the combustion process in accordance with the present invention differs from the chemical looping combustion, where, due to the high reaction heat related to the chemical fixing of oxygen, a lot of heat is released in the regeneration reactor, and efficient means are required to recover the heat from the exhaust gas of the regeneration reactor.

The adsorption and combustion steps are typically carried out at an absolute pressure of about one bar. It is also possible to carry out the steps at a pressure higher than one bar. The upper pressure limit of the adsorption step of the process is determined by economics and limitations of the reaction system and, in general, the steps are desirably carried out at absolute pressures not in excess of about fifty bar. The adsorption step and the combustion step are usually carried out at substantially the same pressure, but in some cases, it is preferred to carry out the combustion step at a pressure slightly below the pressure at which the adsorption step is carried out.

According to an advantageous embodiment of the present invention, the oxygen selective sorbent material is of a perovskite type. The perovskite type material preferably has the structural formula A₁₋ₓMₓBO_{3-δ}, where A is an ion of a metal of Groups 3A and 3B of the periodic table of elements or mixtures thereof, M is an ion of a metal of Groups 1A and 2A of the periodic table or mixtures thereof, B is an ion of a d-block transition metal of the periodic table or mixtures thereof, x varies from 0 to 1, and δ is the deviation from a stoichiometric composition resulting from the substitution of ions of metals of M for ions of metals of A.

According to a preferred embodiment of the present invention, A is at least one f-block lanthanide and/or M is at least one metal of Group 2A of the periodic table of elements, and/or B is Ti, V, Cr, Mn, Fe, Co, Ni, Cu, Zn, or mixtures thereof.

According to another preferred embodiment of the present invention, x is 0.2 to 1 and A is La, Y, Sm or mixtures thereof, and/or M is Sr, Ca, Ba or mixtures thereof, and/or B is V, Fe, Ni, Cu, or mixtures thereof.

The oxygen selective sorbent material may also comprise ceramic substances selected from the group consisting of Bi₂O₃, ZrO₂, CeO₂, ThO₂, HfO₂ and mixtures of these, the ceramic substance being doped with CaO, rare earth metal oxides or mixtures of these. Such a ceramic substance may advantageously be doped with a rare earth metal oxide selected from the group consisting of Y₂O₃, Nb₂O₃, Sm₂O₃, Gd₂O₃ and mixtures of these. The sorbent material may also comprise brownmillerite oxides, or mixtures of any of the above-mentioned materials. As is clear to a skilled person in the art, the sorbent material may also comprise other selective oxide sorbent materials, which can endure in the conditions prevailing in the combustion and adsorption reactors.

The oxygen-selective sorbent material is preferably in a particulate form, which is suitable for use in fluidized bed processes. It may be in the form of a substantially pure oxygen-selective sorbent, or it may be agglomerated with any suitable binder material, i.e., any material, which will not interfere with the performance of the oxygen-selective sorbent or otherwise adversely affect the safety or performance of the system in which the oxygen-selective sorbent is used.

The oxygen-selective sorbent material may be treated with one or more substances which promote the oxygen adsorption properties of the material. Suitable promoters include transition metals, particularly, metals of Groups 1b and 8 of the periodic table of elements. Preferred promoters are Cu, Ag, Fe, Ni, Rh, Pt and mixtures of these. The promoter can be deposited onto the adsorbent in the form of a coating or it can be combined with the adsorbent in any other desired form.

The above brief description, as well as further objects, features, and advantages of the present invention will be more fully appreciated by reference to the following detailed description of the currently preferred, but nonetheless illustrative, embodiments of the present invention, taken in conjunction with the accompanying drawings.

### BRIEF DESCRIPTION OF THE DRAWINGS

FIG. 1 is a schematic diagram of a power plant in accordance with a preferred embodiment of the present invention.

FIG. 2 is a schematic diagram of a power plant in accordance with another preferred embodiment of the present invention.

FIG. 3 is a schematic diagram of a power plant in accordance with a third preferred embodiment of the present invention.

FIG. 4 is a schematic diagram of a power plant in accordance with a fourth preferred embodiment of the present invention.

### DETAILED DESCRIPTION OF THE INVENTION

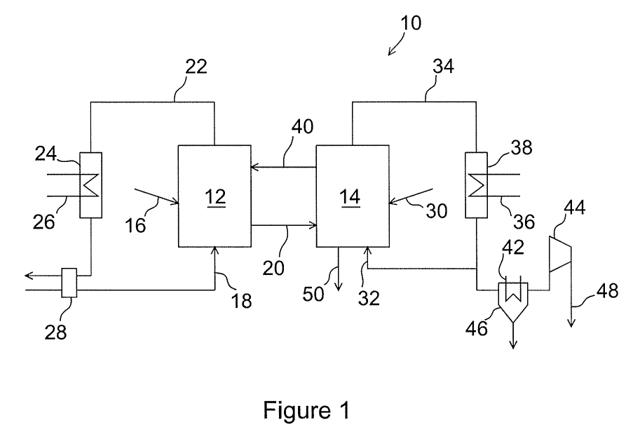

FIG. 1 shows schematically a power plant 10 comprising an adsorption reactor 12 and a combustion reactor 14, in accordance with a preferred embodiment of the present invention. The adsorption reactor 12 comprises means, such as piping, 16 for introducing particulate oxygen selective sorbent to the reactor to form a bed of the sorbent in the reactor. The oxygen selective sorbent comprises perovskite or other suitable material that changes quickly, i.e., faster than a typical residence time of the sorbent in the adsorption reactor, the content of oxygen adsorbed physically into the material as a function of the partial pressure of oxygen. The bed is fluidized by an oxygen-containing fluidizing gas, typically air, introduced into the lower portion of the reactor 12 by conventional fluidizing means 18. The fluidizing means 18 typically comprise a channel for passing compressed air to the reactor and a wind box with a gas distribution plate at the bottom of the reactor (not shown in FIG. 1).

The oxygen-containing fluidizing gas generates a relatively high partial pressure of oxygen p₁ in the adsorption reactor 12. A considerable portion of the oxygen is adsorbed by the oxygen selective sorbent, and thereby oxygen-rich sorbent and oxygen-depleted exhaust gas are formed. The oxygen-depleted exhaust gas is discharged from the reactor to the environment, or to another process, via an exhaust gas channel 22. The oxygen-rich sorbent is conveyed from the reactor to the combustion reactor 14 along a sorbent conveying channel 20.

Generally, the rate and total amount of adsorption of oxygen into the sorbent depends on temperature. The adsorption of oxygen to the sorbent is an exothermic reaction, and thus, the temperature of the adsorption reactor 12 and the discharged exhaust gas are increased. As will be described later, additional heat can be transferred to the adsorption reactor by hot oxygen selective sorbent recycled from the combustion reactor. The exhaust gas channel 22 may advantageously comprise a heat recovery area 24 comprising heat transfer surfaces 26 for recovering heat for suitable purposes, such as for heating the feedwater of a steam generator.

If the temperature of the adsorption reactor is not high enough, more heat can be transferred therein by conventional means, for example, by heating the fluidizing gas of the reactor. According to a preferred embodiment of the present invention, the exhaust gas channel 22 comprises a heat exchanger 28 for transferring heat from the exhaust gas of the adsorption reactor 12 to the fluidizing gas. If the temperature of the adsorption reactor 12 tends to be too high, heat can be transferred therefrom by disposing heat transfer surfaces on the walls of or within the reactor 12 (not shown in FIG. 1).

The adsorption reactor 12 and the combustion reactor 14 may in different applications be fluidized bed reactors of different types. However, the following assumes that both reactors are slow fluidized bed reactors, i.e., the superficial fluidizing gas velocity is so slow, typically, 2-4 m/s, that a definite upper limit is formed on the bed. Therefore, when the oxygen-containing fluidizing gas is introduced at the bottom of the adsorption reactor 12, and the oxygen adsorption is a fast reaction that takes place in the timescale of the flow of the fluidizing gas through the bed, or faster, the partial pressure of oxygen is at its maximum at the bottom portion of the reactor. In these conditions, the amount of oxygen transported by the sorbent can be maximized by connecting the oxygen-rich sorbent conveying line 20 to the lower portion of fluidized bed in the adsorption reactor 12. The transfer of the sorbent along the conveying line 20 can then be based on gravitation or it can be assisted, for example, by a conveying screw or a suitable transfer gas, preferably, steam and/or carbon dioxide.

The combustion reactor 14 comprises means 30, such as a feed supply pipe, duct or trough, for introducing carbonaceous fuel into the reactor. The fuel is preferably particulate solid fuel, such a coal, biofuel or waste fuel. The fuel and the oxygen-rich sorbent conveyed from the adsorption reactor 12 to the combustion reactor 14 are fluidized by an oxygen-deficient fluidizing gas, preferably CO₂, which is introduced to the lower portion of the combustion reactor 14 by conventional fluidizing means 32. Conventional fluidizing means 32 may be similar to conventional fluidizing means 18 discussed above. In the combustion reactor 14 prevails a partial pressure of oxygen p₂′, which is lower than the partial pressure of oxygen p₁ prevailing in the adsorption reactor 12. Thus, oxygen is automatically desorbed from the sorbent material, and the released oxygen is readily available for combusting the carbonaceous fuel. In order to completely combust the fuel and to minimize the O₂-content in the exhaust gas, the circulation rate of the sorbent and the feed rate of the fuel are advantageously adjusted such that the amount of oxygen released in the combustion chamber is slightly more, preferably, 10-25% more, even more preferably, 10-15% more, than what is theoretically needed for completely combusting the fuel.

An exhaust gas channel 34 is connected to the upper portion of the combustion reactor 14. The combustion of the fuel is an exothermic reaction releasing energy. Thus, the combustion increases the temperature in the combustion reactor 14, and enhances the releasing of oxygen from the sorbent. Most of the heat released from the combustion is advantageously recovered by heat transfer surfaces disposed in the combustion reactor 14 (not shown in FIG. 1) and by heat exchange surfaces 36 disposed in a heat recovery area 38 in the exhaust gas channel 34, for generating steam.

When the particle bed in the combustion reactor 14 is fluidized by carbon dioxide, the exhaust gas comprises mainly CO₂ and water. The exhaust gas channel 34 of the power plant 10 is advantageously equipped with means for cooling 42 and for compressing 44 the exhaust gas. Thereby, a stream of water 46 and possible other condensable impurities can be separated in a conventional manner from the remaining relatively clean stream of carbon dioxide 48, which can then be recovered, preferably in liquid form. In FIG. 1 is schematically shown only a single means for cooling and compressing the exhaust gas, but in practice, the apparatus preferably comprises multiples of such stages connected in series.

To the combustion reactor 14 is advantageously connected a channel 40 for returning oxygen-depleted sorbent from the combustion reactor 14 to the adsorption reactor 12. Thereby, the returned sorbent is reloaded with oxygen in the adsorption reactor 12 before it is again recirculated to the combustion reactor 14. Because the combustion reactor is generally at a higher temperature than is the adsorption reactor, the oxygen-depleted sorbent may also be used to transfer heat from the combustion reactor to the adsorption reactor, if necessary.

Generally, the combustion reactor 14, or, alternatively or additionally, the adsorption reactor 12, comprises means for discharging ash 50, i.e., an uncombustible component of the fuel, from the system. The means for discharging ash 50 may advantageously comprise conventional means for screening sorbent particles from the ash before it is discharged (not shown in FIG. 1). However, in many cases, the sorbent material becomes deteriorated by impurities of the fuel, such as sulfur, when being used long enough in the process. Thereby, a portion of the used sorbent shall be removed from the system, either together with the ash or separately, and a corresponding amount of fresh sorbent shall be introduced into the system. In such a case, the sorbent functions also as a means for removing impurities from the process. The removed impurities containing sorbent can be transported to a waste disposal area or for further use. The plant 10 may also comprise means for cleaning the removed sorbent from the adsorbed impurities (not shown in FIG. 1), whereby cleaned sorbent can be reused as an oxygen carrier.

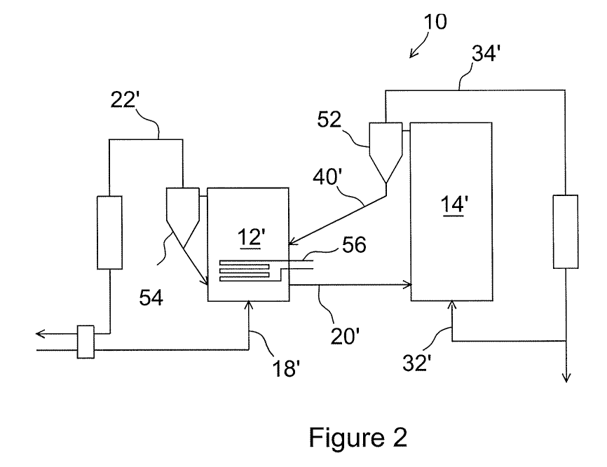

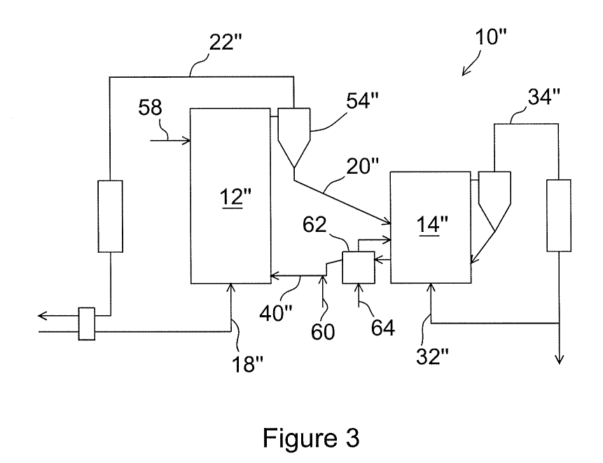

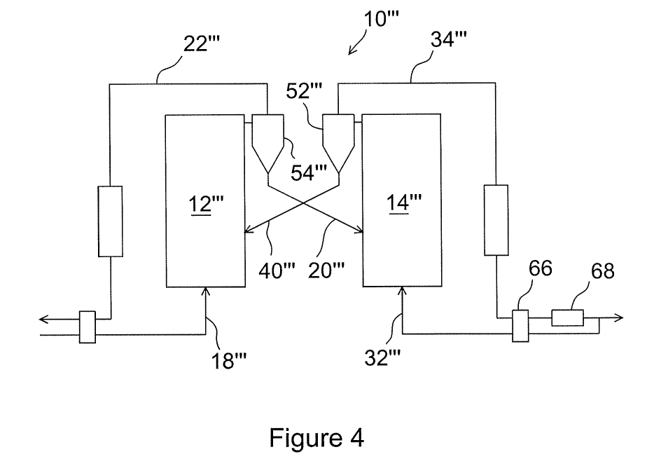

FIG. 2 shows schematically another power plant 10′ in accordance with another preferred embodiment of the present invention. In FIGS. 1 and 2, and also correspondingly in FIGS. 3 and 4, all the corresponding elements have the same reference numbers, differentiated only by the number of apostrophes attached to the reference number.

The power plant 10′ differs from that shown in FIG. 1 in that the adsorption reactor 12′ is a slow fluidized bed reactor, and the combustion reactor 14′ is a fast fluidized bed reactor. Thus, the combustion reactor 14′ is fluidized by using such a high fluidizing gas velocity, typically 5-10 m/s, that the fluidized bed in the reactor does not have a definite upper surface, but a continuously decreasing particle distribution extends to the top of the reactor enclosure. As a result, a considerable amount of bed particles is entrained with the exhaust gas from the reactor 14′ to a separator 52, which separates most of the entrained particles from the exhaust gas. The thus cleaned exhaust gas is then conveyed to the exhaust gas channel 34′ and the separated sorbent and ash particles are conducted via a channel 40′ to the adsorption reactor 12′.

An advantage of the apparatus shown in FIG. 2 is that due to the high fluidizing velocity, the contacts between the different materials are especially intense within the bed, and the heat and material distributions in the combustion reactor 14′ are relatively uniform. Thus, the processes in the reactor are efficient and well controllable. The plant shown in FIG. 2 is especially suitable for combusting very reactive fuels, whereby the particles separated from the exhaust gas do not contain any significant amount of uncombusted carbon.

The adsorption reactor 12′ shown in FIG. 2 is a slow fluidized bed reactor, fluidized with air, where the fluidizing velocity is so slow that the particle bed contains a definite upper level and no significant amount of bed particles are entrained with the fluidizing gas. If needed, the reactor 12′ may comprise a separator 54 for separating particles from the exhaust gas to be returned to the reactor 12′. The slow fluidized bed in the reactor 12′ may advantageously contain heat transfer surfaces 56 within the bed to control the temperature in the reactor.

The oxygen-rich sorbent can be conveyed from the adsorption reactor 12′ to the combustion reactor 14′ by means of gravity or as assisted by a suitable means, such as suitable carrier gas. The channel 20′ for conveying oxygen-rich sorbent, at a controlled rate, from the adsorption reactor is preferably connected to the lower portion of the adsorption reactor. Thereby, when having a sufficiently large bed volume in the reactor and when the oxygen-depleted sorbent is introduced above the upper surface of the bed, a sufficiently long residence time of the sorbent in the bed can be guaranteed. Moreover, while the sorbent is removed from the portion of the adsorption reactor 12′ where the partial pressure of oxygen has its highest value, the final oxygen content of the removed sorbent material is as high as it can be.

Alternatively, the oxygen-rich sorbent can be removed simply as an overflow from the top of the particle bed in the adsorption reactor 12′. In that case, special precautions may be needed to guarantee a sufficient residence time of the sorbent in the reactor. The sorbent may, for example, be introduced to the lower portion of the reactor, or the reactor may have an extended horizontal dimension to increase the residence time of the sorbent in the reactor.

FIG. 3 shows schematically still another power plant 10″ in accordance with another preferred embodiment of the present invention. This power plant 10″ differs from those shown in FIGS. 1 and 2 in that the adsorption reactor 12″ is a fast fluidized bed reactor and the combustion reactor 14″ is a slow fluidized bed reactor.

An advantage of operating the adsorption reactor 12″ as a fast fluidized bed is that, due to the vigorous mixing and the high amount of fluidizing gas, usually air, conveyed through the bed, the process conditions within the bed are relatively uniform and the general rate of oxygen adsorption in the sorbent material is high. Especially, if the oxygen selective sorbent material reacts very fast to the partial pressure of oxygen p₁, it may be useful to still enhance the total adsorption by having additional air injection means 58 in the upper portion of the reactor 12″.

The oxygen-rich sorbent material entrained with the fluidizing gas is separated by a particle separator 54″ from the gas discharged from the reactor 12″. The separated particles can then advantageously be transported via a sloped conveying channel 20″ to the combustion reactor 14″.

The use of a slow fluidized bed in the combustion reactor 14″ brings about the advantage that, because the required fluidizing velocity is low, typically 2-4 m/s, the required rate of recirculating the exhaust as a fluidizing gas along line 32″ is relatively low.

The oxygen-depleted sorbent is advantageously transported from the combustion reactor 14″ to the adsorption reactor 12″ along a channel 40″ either as an overflow from the upper portion of the slow fluidized bed, or as an assisted flow from a lower portion of the bed. According to a preferred embodiment of the present invention, the oxygen-rich sorbent is introduced to the reactor 14″ above the upper level of the slow fluidized bed, and the oxygen-depleted sorbent is removed from the reactor via a discharge channel 40″ connected to the lower portion of the reactor 14″.

The discharge channel 40″ may advantageously comprise means 60 for injecting carrier gas, preferably air, to the channel to control the flow of the sorbent material in the channel. If the material discharged from the reactor 14″ comprises too high amounts of other material than the oxygen selective sorbent, such as uncombusted fuel particles, the discharge channel may comprise a particle screening unit 62 for selecting the fraction of material to be conveyed to the adsorption reactor. The selection of material may be carried out by conventional means, such as a mechanical particle screen or by the injection of suitable fluidizing gas 64. The rejected material fractions can then be, for example, returned to the combustion reactor 14″ or disposed.

FIG. 4 shows schematically a still further power plant 10′″ in accordance with a further embodiment of the present invention. The power plant 10′″ differs from that shown in FIGS. 1, 2 and 3 in that both the adsorption reactor 12′″ and the combustion chamber 14′″ are operated as fast fluidized bed reactors. Thus, both of the reactors 12′″ and 14′″ comprise a separator, 54′″ and 52′″, for separating material from the corresponding exhaust gas, respectively, to be returned to the other reactor via a sloped channel, 20′″ and 40′″, respectively. When compared to the previously described embodiments, the boiler plant 10′″ provides the advantage that it can be relatively easily scaled up for large capacity boiler plants.

The fast fluidized bed reactors 12′″ and 14′″ in FIG. 4 provide similar advantages as those of the individual fast fluidized bed reactors 12″ and 14′ described in connection with FIGS. 3 and 2, respectively.

The exhaust gas channel 34′″ advantageously comprises a heat exchanger 66 for transferring heat from the exhaust gas discharged from the combustion reactor 14′″ to that portion of the exhaust gas, which is returned as a fluidizing gas back to the combustion reactor 14′″ along the fluidizing means 32′″. The channel 32′″ may advantageously also comprise, upstream of the branch point of the returned exhaust gas, a dust separator 68, such as an electrostatic precipitator, for separating remaining small particles from the exhaust gas before a portion of it is recirculated into the combustion reactor 14′″.

While the invention has been described herein by way of examples in connection with what are at present considered to be the most preferred embodiments, it is to be understood that the invention is not limited to the disclosed embodiments, but is intended to cover various combinations or modifications of its features and several other applications included within the scope of the invention as defined in the appended claims. For example, as is clear to a person skilled in the art, means for feeding of gas 58 to the upper portion of the adsorption reactor, or a particle screening unit 62, or a heat exchanger 66 and dust separator 68, can be used in many different embodiments.

We claim:

1. A method of combusting carbonaceous fuel in a combustion plant, the method comprising the steps of:
(a) introducing particulate oxygen selective sorbent into an adsorption reactor of the combustion plant to form a first particle bed in the adsorption reactor;
(b) fluidizing the first particle bed by an oxygen-containing first fluidizing gas to provide a first partial pressure of oxygen p₁ in the adsorption reactor to adsorb oxygen from the fluidizing gas to the sorbent, so as to produce oxygen-rich sorbent and oxygen-depleted exhaust gas;
(c) discharging oxygen-depleted exhaust gas from the adsorption reactor along a first exhaust gas channel;
(d) conveying oxygen-rich sorbent from the adsorption reactor to a combustion reactor of the combustion plant along a sorbent conveying channel to form a second particle bed in the combustion reactor;
(e) fluidizing the second particle bed by an oxygen-deficient second fluidizing gas to provide a second partial pressure of oxygen p₂ in the combustion reactor, where p₂ is less than p₁, to desorb oxygen from the sorbent, so as to produce free oxygen gas and oxygen-depleted sorbent;
(f) introducing carbonaceous fuel into the combustion reactor to oxidize the fuel with the free oxygen gas, and to produce carbon dioxide containing exhaust gas, and to maintain a low partial pressure of oxygen p₂′ in the combustion reactor, where p₂′ is less than p₁, to continue desorbing oxygen from the sorbent; and
(g) discharging carbon dioxide containing exhaust gas from the combustion reactor along a second exhaust gas channel.

2. The method according to claim 1, wherein the method comprises a further step of returning at least a portion of the oxygen-depleted sorbent from the combustion reactor to the adsorption reactor along a sorbent return channel.

3. The method according to claim 1, wherein the method comprises a further step of discharging at least a portion of the oxygen-depleted sorbent from the combustion plant so as to remove impurities adsorbed in the sorbent.

4. The method according to claim 3, wherein the method comprises further steps of regenerating at least a portion of the discharged sorbent by removing impurities adsorbed in the sorbent, and returning at least a portion of the regenerated sorbent in the regenerating step to the adsorption reactor.

5. The method according to claim 1, wherein the first fluidizing gas comprises air.

6. The method according to claim 1, wherein the second fluidizing gas comprises carbon dioxide.

7. The method according to claim 6, wherein at least a portion of the second fluidizing gas is obtained as a side stream of the carbon dioxide containing exhaust gas.

8. The method according to claim 6, wherein the second fluidizing gas comprises steam.

9. The method according to claim 1, wherein the carbonaceous fuel is solid fuel.

10. The method according to claim 9, wherein the carbonaceous fuel comprises at least one of coal, biofuel and waste derived fuel.

11. The method according to claim 1, wherein the adsorption reactor is a slow fluidized bed reactor.

12. The method according to claim 11, wherein in step (a) oxygen selective sorbent is introduced at the upper portion of the adsorption reactor and in step (d) oxygen-rich sorbent is conveyed from the lower portion of the adsorption reactor.

13. The method according to claim 1, wherein the adsorption reactor is a fast fluidized bed reactor.

14. The method according to claim 13, wherein the adsorption reactor comprises a particle separator for separating oxygen-rich sorbent from the oxygen-depleted gas, and step (d) comprises conveying the separated oxygen-rich sorbent into the combustion reactor.

15. The method according to claim 2, wherein the combustion reactor is a slow fluidized bed reactor.

16. The method according to claim 15, wherein in step (d) oxygen-rich sorbent is introduced at the upper portion of the combustion reactor and in step (h) oxygen-depleted sorbent is returned from the lower portion of the adsorption reactor.

17. The method according to claim 2, wherein the combustion reactor is a fast fluidized bed reactor.

18. The method according to claim 17, wherein the combustion reactor comprises a particle separator for separating oxygen-depleted sorbent from the carbon dioxide containing exhaust gas, and step (h) comprises conveying the separated oxygen-depleted sorbent into the adsorption reactor.

19. The method according to claim 1, wherein the oxygen selective sorbent comprises a perovskite type material.

20. The method according to claim 19, wherein the perovskite type material has a structural formula A₁₋ₓMₓBO_{3-δ}, where A is an ion of a metal of Groups 3A and 3B of the periodic table of elements or mixtures thereof, M is an ion of a metal of Groups 1A and 2A of the periodic table of elements or mixtures thereof, B is an ion of a d-block transition metal of the periodic table of elements or mixtures thereof, x varies from 0 to 1, and δ is the deviation from a stoichiometric composition resulting from the substitution of ions of metals of M for ions of metals of A.

21. The method according to claim 20, wherein at least one of (i) A is at least one f-block lanthanide, (ii) M is at least one metal of Group 2a of the periodic table of elements, and (iii) B is Ti, V, Cr, Mn, Fe, Co, Ni, Cu, Zn or mixtures thereof.

22. The method according to claim 20, wherein x is 0.2 to 1 and at least one of (i) A is La, Y, Sm or mixtures thereof, (ii) M is Sr, Ca, Ba or mixtures thereof, and (iii) B is V, Fe, Ni, Cu or mixtures thereof.

23. The method according to claim 1, wherein the oxygen selective sorbent comprises ceramic substances selected from the group consisting of Bi₂O₃, ZrO₂, CeO₂, ThO₂, HfO₂ and mixtures of these, the ceramic substance being doped with at least one of CaO, rare earth metal oxides and mixtures of CaO and rare earth metal oxides.

24. The method according to claim 23, wherein the ceramic substance is doped with a rare earth metal oxide selected from the group consisting of Y₂O₃, Nb₂O₃, Sm₂O₃, Gd₂O₃ and mixtures of these.

25. The method according to claim 1, wherein the oxygen selective sorbent comprises brownmillerite oxides.

26. The method according to claim 1, wherein the oxygen selective sorbent is treated by a substance that promotes the oxygen adsorption properties of the material.

27. The method according to claim 26, wherein the promoter substance comprises transition metals of Groups 1B and 8 of the periodic table of elements.

28. The method according to claim 26, wherein the promoter substance is selected from the group consisting of Cu, Ag, Fe, Ni, Rh, Pt or mixtures of these.

29. The method according to claim 1, wherein the method comprises a further step of recovering carbon dioxide from the carbon dioxide containing exhaust gas.

30. The method according to claim 1, wherein the method comprises a further step of generating steam by using heat transfer surfaces in the combustion reactor and in at least one of the adsorption reactor, first exhaust gas channel and second exhaust gas channel.

31. The method according to claim 1, wherein the method comprises a further step of heating the first fluidizing gas with heat recovered from the oxygen-depleted exhaust gas.

32. The method according to claim 1, wherein the method comprises a further step of heating the second fluidizing gas with heat recovered from the carbon dioxide containing exhaust gas.

33. A combustion plant for combusting carbonaceous fuel, the plant comprising:
an adsorption reactor and a combustion reactor;
means for introducing particulate oxygen selective sorbent into the adsorption reactor;
means for fluidizing a bed of the oxygen selective sorbent by an oxygen-containing first fluidizing gas for producing oxygen-rich sorbent and oxygen-depleted exhaust gas;
means for discharging oxygen-depleted exhaust gas from the adsorption reactor;
means for conveying oxygen-rich sorbent from the adsorption reactor to the combustion reactor;
means for fluidizing a bed provided in the combustion reactor by an oxygen-deficient second fluidizing gas, so as to desorb oxygen from the sorbent and to produce oxygen-depleted sorbent;
means for introducing carbonaceous fuel into the combustion reactor to oxidize the fuel with the desorbed oxygen, to produce carbon dioxide containing exhaust gas, and to maintain a low partial pressure of oxygen in the combustion reactor to continuously desorb oxygen from the sorbent; and
means for discharging carbon dioxide containing exhaust gas from the combustion reactor.

34. The combustion plant according to claim 33, wherein the plant comprises means for conveying at least a portion of the oxygen-depleted sorbent from the combustion reactor to the adsorption reactor.

35. The combustion plant according to claim 33, wherein the plant comprises means for discharging at least a portion of the oxygen-depleted sorbent from the combustion plant so as to remove impurities adsorbed in the sorbent.

36. The combustion plant according to claim 35, wherein the plant comprises means for regenerating at least a portion of the discharged sorbent by removing impurities adsorbed in the sorbent, and means for returning at least a portion of the regenerated sorbent to the adsorption reactor.

37. The combustion plant according to claim 33, wherein the plant comprises means for arranging a side stream of the carbon dioxide containing exhaust gas in flow connection with the means for fluidizing the bed provided in the combustion reactor by an oxygen-deficient second fluidizing gas.

38. The combustion plant according to claim 33, wherein the adsorption reactor is a slow fluidized bed reactor.

39. The combustion plant according to claim 38, wherein the means for introducing oxygen selective sorbent to the adsorption reactor are connected to the upper portion of the adsorption reactor and the means for conveying oxygen-rich sorbent from the adsorption reactor to the combustion reactor are connected to the lower portion of the adsorption reactor.

40. The combustion plant according to claim 33, wherein the adsorption reactor is a fast fluidized bed reactor.

41. The combustion plant according to claim 40, wherein the adsorption reactor comprises a particle separator for separating oxygen-rich sorbent from the oxygen-depleted gas, and the means for conveying oxygen-rich sorbent from the adsorption reactor to the combustion reactor comprises means for conveying the separated oxygen-rich sorbent to the combustion reactor.

42. The combustion plant according to claim 34, wherein the combustion reactor is a slow fluidized bed reactor.

43. The combustion plant according to claim 42, wherein the means for conveying oxygen-rich sorbent to the combustion reactor is connected to the upper portion of the combustion reactor and the means for conveying oxygen-depleted sorbent from the combustion reactor to the adsorption reactor is connected to the lower portion of the combustion reactor.

44. The combustion plant according to claim 34, wherein the combustion reactor is a fast fluidized bed reactor.

45. The combustion plant according to claim 44, wherein the combustion reactor comprises a particle separator for separating oxygen-depleted sorbent from the carbon dioxide containing exhaust gas, and the means for conveying oxygen-depleted sorbent from the combustion reactor to the adsorption reactor comprises means for conveying the separated oxygen-rich sorbent to the adsorption reactor.

46. The combustion plant according to claim 33, wherein the plant comprises means recovering carbon dioxide from the carbon dioxide containing exhaust gas.

47. The combustion plant according to claim 33, wherein the plant comprises means for generating steam including heat transfer surfaces in the combustion reactor and in at least one of the adsorption reactor, first exhaust gas channel and second exhaust gas channel.

48. The combustion plant according to claim 33, wherein the plant comprises means for heating the first fluidizing gas with heat recovered from the oxygen-depleted exhaust gas.

49. The combustion plant according to claim 33, wherein the plant comprises means for heating the second fluidizing gas with heat recovered from the carbon dioxide containing exhaust gas.
